(19) United States
(12) Patent Application Publication
(10) Pub. No.: US 2010/0213286 A1
(43) Pub. Date: Aug. 26, 2010

(54) ADJUSTING AND FILTER ARRANGEMENT FOR AN INJECTION VALVE AND INJECTION VALVE

(76) Inventors: Mauro Grandi, Livorno (IT); Matteo Soriani, Livorno (IT)

Correspondence Address: King & Spalding LLP, 401 Congress Avenue, Suite 3200, Austin, TX, 78701, US

(21) Appl. No.: 12/602,777

(22) PCT Filed: May 30, 2008
(86) PCT No.: PCT/EP2008/056670

§ 371 Date: Dec. 3, 2009

(30) Foreign Application Priority Data
Jun. 4, 2007 (EP) 07010968.1

(51) Int. Cl. F02M 61/04; B01D 35/02; B01D 35/157

(52) U.S. Cl. 239/575; 210/429

(57) ABSTRACT

The injection valve has a housing and a cavity with a fluid inlet portion and a fluid outlet portion, a valve needle axially movable in the cavity, the valve needle preventing a fluid flow in a closing position and releasing the fluid flow in further positions, and a spring element mechanically coupled to the needle and designed to exert an axial force on the needle. The adjusting and filter arrangement is arrangeable in the cavity between the inlet and outlet portion and has a filter element formed as a filtration body block and designed to filter the fluid, an adjusting element rigidly coupled to the housing and to preload the spring element and formed as an outer casing for the filter element, and a spring guiding element extending in axial direction and engaging the spring element, wherein the adjusting element and the spring guiding element form a one-piece element.

### CROSS-REFERENCE TO RELATED APPLICATIONS

This application is a U.S. National Stage Application of International Application No. PCT/EP2008/056670 filed May 30, 2008, which designates the United States of America, and claims priority to EP Application No. 07010968.1 filed Jun. 4, 2007, the contents of which are hereby incorporated by reference in their entirety.

### TECHNICAL FIELD

The invention relates to an adjusting and filter arrangement for an injection valve and an injection valve for a combustion chamber of a combustion engine.

### BACKGROUND

Injection valves are in widespread use, in particular for internal combustion engines where they may be arranged in order to dose fluid into an intake manifold of the internal combustion engine or directly into the combustion chamber of a cylinder of the internal combustion engine.

Injection valves are manufactured in various forms in order to satisfy the various needs for the various combustion engines. Therefore, for example, their length, their diameter, and also various elements of the injection valve being responsible for the way the fluid is dosed may vary in a wide range. In addition to that, injection valves may accommodate an actuator for actuating a needle of the injection valve, which may, for example, be an electromagnetic actuator or a piezoelectric actuator.

In order to enhance the combustion process in view of the creation of unwanted emissions, the respective injection valve may be suited to dose fluids under very high pressures. The pressures may be in the case of a gasoline engine in the range of up to 200 bar and in the case of a diesel engine in the range of up to 2 000 bar, for example.

EP 1 296 057 A1 discloses an integrated fuel filter and calibration tube for a fuel injector. The integrated fuel filter and calibration tube for the fuel injector is preferably made from a filtration element. The filtration element comprises filtration media insert-molded into a thermoplastic frame member. Further, the integrated fuel filter and calibration tube is made from a metal calibration tube wretchedly attached to the filtration element. The calibration tube is sized so as to fit inside of a fuel injector flow channel.

U.S. Pat. No. 5,340,032 discloses an injection valve including a fuel filter that has a filter housing on which a return spring is supported and which includes a frame that is pressed into a flow hole so that the force introduced by the return spring onto the filter is guided via the filter housing and the frame pressed into the core.

### SUMMARY

According to various embodiments, an adjusting and filter arrangement for an injection valve and a respective injection valve can be created which may be manufactured in a simple way and which facilitates a reliable and precise function.

According to an embodiment, an adjusting and filter arrangement for an injection valve, wherein the injection valve comprises a housing including a central longitudinal axis, the housing comprising a cavity with a fluid inlet portion and a fluid outlet portion, a valve needle axially movable in the cavity, the valve needle preventing a fluid flow through the fluid outlet portion in a closing position and releasing the fluid flow through the fluid outlet portion in further positions, and a spring element being mechanically coupled to the valve needle and being designed to exert an axial force on the valve needle, is arrangeable in the cavity between the fluid inlet portion and the fluid outlet portion and comprising a filter element being formed as a filtration body block and being designed to filter the fluid flowing from the fluid inlet portion to the fluid outlet portion, an adjusting element being designed to be rigidly coupled to the housing and to preload the spring element and being formed as an outer casing for the filter element, and a spring guiding element extending in axial direction and being designed to be in engagement with the spring element, wherein the adjusting element and the spring guiding element are forming a one-piece element.

According to a further embodiment, the adjusting and filter arrangement may comprise an orifice being designed to allow a fluid flow from the fluid inlet portion to the fluid outlet portion and to dampen a pressure fluctuation at the fluid outlet portion. According to a further embodiment, the filter element may be arranged at a first end of the adjusting and filter arrangement and the orifice being arranged at a second end of the adjusting and filter arrangement, the first end being opposite to the second end of the adjusting and filter arrangement. According to a further embodiment, the spring guiding element may have the shape of a cylindrical piston. According to a further embodiment, the spring guiding element may comprise the orifice.

According to a further embodiment, an injection valve may comprise such an adjusting and filter arrangement as described above.

According to a further embodiment, the adjusting element can be arranged in the cavity in a manner that the adjusting element is force-fit coupled to the housing.

### BRIEF DESCRIPTION OF THE DRAWINGS

Exemplary embodiments are explained in the following with the aid of schematic drawings. These are as follows:

FIG. 1 an injection valve with an adjusting and filter arrangement in a longitudinal section view,

FIG. 2 the adjusting and filter arrangement of the injection valve in a perspective view.

Elements of the same design and function that appear in different illustrations are identified with a same reference characters.

### DETAILED DESCRIPTION

According to a first aspect, in an adjusting and filter arrangement for an injection valve, the injection valve comprises a housing including a central longitudinal axis, the housing comprising a cavity with a fluid inlet portion and a fluid outlet portion, a valve needle axially movable in the cavity, the valve needle preventing a fluid flow through the fluid outlet portion in a closing position and releasing the fluid flow through the fluid outlet portion in further positions, and a spring element being mechanically coupled to the valve needle and being designed to exert an axial force on the valve needle. The adjusting and filter arrangement is arrangeable in the cavity between the fluid inlet portion and the fluid outlet portion and comprises a filter element being formed as a filtration body block and being designed to filter the fluid flowing from the fluid inlet portion to the fluid outlet portion, an adjusting element being designed to be rigidly coupled to the housing and to preload the spring element and being formed as an outer casing for the filter element, and a spring guiding element extending in axial direction and being designed to be in engagement with the spring element, wherein the adjusting element and the spring guiding element are forming a one-piece element.

The filter element being formed as a filtration body block enables a filtration of particles in all three dimensions of the filter. This filter element is preferably built up as a three dimensional web structure which enables to filter the particles very efficient. The adjusting element is forming a outer housing for the filter element.

The advantage of this valve assembly is that the adjusting process, i.e. exerting an axial preload force on the spring element, can be carried out during the running-in of the injector with a low risk that particles are contaminating the fluid outlet portion as the filter element is in its final position from the beginning of the adjusting process. Furthermore, a radial movement of the spring element relative to the central longitudinal axis can be kept small as the spring guiding element is engaging the spring element.

In an embodiment the adjusting and filter arrangement comprises an orifice being designed to allow a fluid flow from the fluid inlet portion to the fluid outlet portion and to dampen a pressure fluctuation at the fluid outlet portion in particular in respect to a pressure fluctuation at the fluid inlet portion. This has the advantage that the orifice can act as an attenuation element, in a manner that pressure fluctuations in a section of the cavity downstream the orifice can be smaller than the pressure fluctuations occurring in a section of the cavity upstream the orifice.

In a further embodiment the filter element is arranged at a first end of the adjusting and filter arrangement and the orifice is arranged at a second end of the adjusting and filter arrangement, the first end being opposite to the second end of the adjusting and filter arrangement. This has the advantage that a simple construction of the adjusting and filter arrangement is possible as the orifice can be manufactured in the end of the manufacturing process of the whole adjusting and filter arrangement. Consequently, an individual size for the orifice can be obtained according to the relevant conditions in view of the desired reduction of pressure fluctuations in the cavity.

In a further embodiment the spring guiding element has the shape of a cylindrical piston. This has the advantage that the spring guiding element can be in engagement with a cylindrical recess of the spring element.

In a further embodiment the spring guiding element comprises the orifice. This has the advantage that a simple construction of the adjusting and filter arrangement and in particular of the orifice is possible.

According to a second aspect, an injection valve may comprise the adjusting and filter arrangement in accordance with the first aspect, with the adjusting element being arranged in the cavity in a manner that the adjusting element is force-fit coupled to the housing.

This has the advantage that an adjusting process of the adjusting and filter arrangement allows to obtain a precise and fixed positioning of the adjusting and filter arrangement relative to the housing and the spring element without additional process steps like crimping.

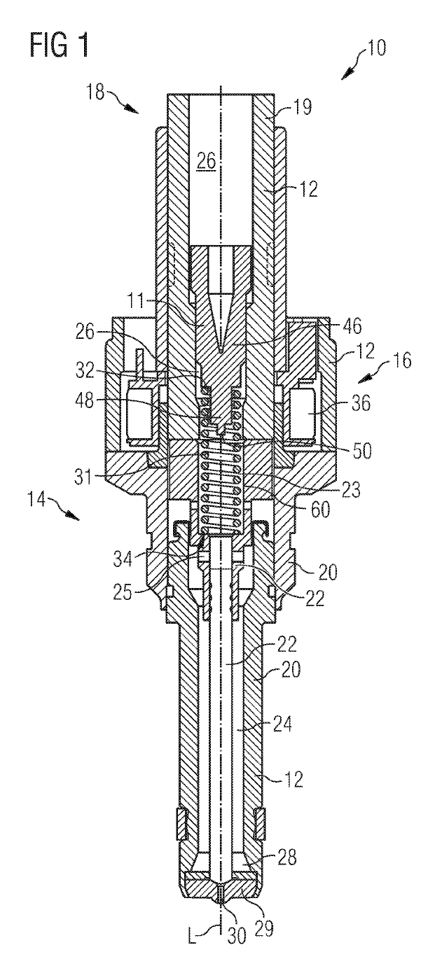

An injection valve 10 (FIG. 1) may be used as a fuel injection valve for a combustion chamber of an internal combustion engine and comprises a housing 12 which is of a tubular shape with a central longitudinal axis L. Furthermore, the injection valve 10 comprises an adjusting and filter arrangement 11, a valve assembly 14, an actuator unit 16 and a fuel connector 18.

The fuel connector 18 is designed to be connected to a high-pressure fuel chamber of the internal combustion engine, the fuel is stored under high pressure, for example, under the pressure of about 200 bar in the case of a gasoline engine or of about 2000 bar in the case of a diesel engine.

The fuel connector 18 has an inlet tube 19 and is fixed to the actuator unit 16 on one of its free ends. On its upper end the fuel connector 18 comprises a fluid inlet portion 26.

The adjusting and filter arrangement 11 is arranged in the fluid inlet portion 26 of the inlet tube 19.

The valve assembly 14 comprises a valve body 20 being part of the housing 12. The valve assembly 14 further comprises a valve needle 22. The valve needle 22 is arranged in a recess 24 of the valve body 20. The valve needle 22 is rigidly coupled to an armature 40 which has a recess 23 being arranged in direction of the central longitudinal axis L over a portion of the axial length of the armature 40. The armature 40 has openings 25 which couple the recess 23 of the armature 40 hydraulically to the recess 24 of the valve body 20. The recess 23 of the armature 40, the openings 25, the recess 24 of the valve body 20, the fluid inlet portion 26 and a fluid outlet portion 28 are forming a cavity and are parts of a fluid line which is axially led through the housing 12 and which allows a fluid flow from the fluid inlet portion 26 to the fluid outlet portion 28.

The fluid outlet portion 28 is formed on one of the free ends of the cavity 24 of the valve body 20 and is closed or opened depending on the axial position of the valve needle 22. In a closing position of the valve needle 22 it rests sealingly on a seat 29 thereby preventing a fluid flow through at least one injection nozzle 30 in the valve body 20. The injection nozzle 30 may be for example an injection hole, but it may also be of some other type suitable for dosing fluid. The seat 29 may be made in one part with the valve body 20 or may be a separate part from the valve body 20.

A spring element 31 is arranged in the recess of the valve needle 22 preferably to rest on a first spring rest 32 on the adjusting and filter arrangement 11 and a second spring rest 34 on the armature 40. Consequently, as the armature 40 is coupled to the valve needle 22 the spring element 31 is mechanically coupled to the valve needle 22.

The actuator unit 16 is inserted into the housing 12 and has an electromagnetic unit comprising a coil 36, which is preferably extrusion-coated. The coil 36, the inlet tube 19, the valve body 20 and the valve needle 22 are all forming an electromagnetic circuit.

If the coil 36 is energized this results in an electromagnetic force acting on the valve needle 22. The electromagnetic force acts against the mechanical force obtained from the spring element 31. By appropriately energizing the coil 36, the valve needle 22 may in that way be moved away from its closing position which results in a fluid flow through the injection nozzle 30. After a predetermined time the coil 36 may be de-energized again.

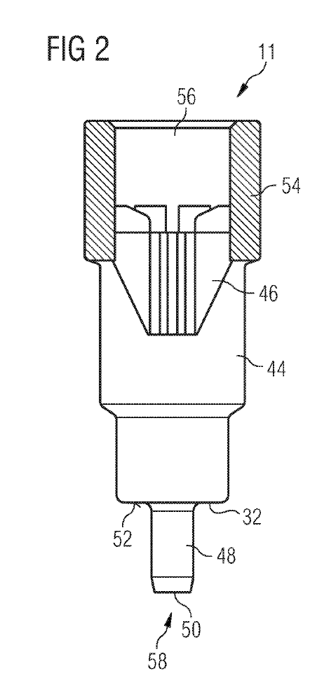

FIG. 2 shows the adjusting and filter arrangement 11 in an enlarged detailed view.

The adjusting and filter arrangement 11 is arranged in the fluid inlet portion 26 which is part of the cavity of the housing 12.

The adjusting and filter arrangement 11 comprises an adjusting element 44, which is forming a one-piece element with a filter element 46.

The filter element 46 is designed to filter fluid flowing from the fluid inlet portion 26 of the injection valve 10 to the fluid outlet portion 28. The filter element 46 is formed as a filtration body block, i.e. that the filtration of particles is carried out in all the three dimensions of the filter element 46 which allows a very efficient filtration of particles. Preferably, the filter element 46 is built up as a three dimensional web structure. Preferably, the filter element 46 is of a material comprising nylon.

The adjusting element 44 can be coupled rigidly to the housing 12 and exert an axial force on the spring element 31 in a way that the spring element 31 is biased.

Furthermore, the adjusting and filter arrangement 11 comprises a spring guiding element 48 which is forming a one-piece element with the adjusting element 44. The spring guiding element 48 is of a cylindrical shape and is forming a piston which, as can be seen in FIG. 1, is in engagement with a recess of the spring element 31 which is formed as a coil spring. As the diameter of the spring guiding element 48 and the diameter of the recess of the spring element 31 are of the same size, the radial movement of the spring element 31 relative to the central longitudinal axis L is very small. This makes it possible that the spring element 31 has a distance to an inner wall 60 of the armature 40 formed by the recess 23 of the armature 40. By this, interference between the spring element 31 and the inner wall 60 of the armature 40 can be prevented.

The adjusting and filter arrangement 11 has a first end 56 and a second end 58, the first end 56 is opposite to the second end 58 of the adjusting and filter arrangement 11.

At the first end 56 of the adjusting and filter arrangement 11 guiding elements 54 are arranged which enable to insert the adjusting and filter arrangement 11 into the fluid inlet portion 26 during the assembling process. By this, a proper insert of the adjusting and filter arrangement 11 is enabled. At the second end 58 of the adjusting and filter arrangement 11, the spring guiding element 48 has an orifice 50. The orifice 50 enables that pressure fluctuations occurring in the cavity of the housing 12 upstream the orifice 50, in particular in the fluid inlet portion 26, can be dampened. This means that in the cavity of the housing 12 downstream the orifice 50 the pressure fluctuations of the fluid can be kept smaller than in the cavity of the housing 12 upstream the orifice 50. This allows a very precise dosing of fluid through the injection nozzle 30.

The injection valve 10 is assembled by inserting the adjusting and filter arrangement 11 into the fluid inlet portion 26 and then exerting a force on the adjusting and filtering element 11 in direction of the longitudinal axis L to press the adjusting and filter arrangement 11 further into the fluid inlet portion 26. To adjust the fluid flow through the fluid outlet portion 28 the adjusting and filter arrangement 11 is moved in an axial direction thereby compressing the spring element 31. The transmission of the force from the adjusting and filter element 11 to the spring element 31 to bias the spring element 31 is possible as the spring element 31 is in contact with the adjusting and filter arrangement 11 via a spring contact surface 52 of the first spring rest 32. The force of the biased spring element 31 is applied on the valve needle 22. By this the fluid flow through the fluid outlet portion 28 is adjustable until it reaches its predetermined value. After this the axial movement of the adjusting and filter arrangement 11 is terminated. From then on the adjusting and filter element 11 is rigidly fixed relative to the housing 12 due to the force-fit coupling between the adjusting and filter element 11 and the housing 12.

The function of the injection valve 10 is described in the following:

The fluid may flow from the fluid inlet portion 26 of the fuel connector 18 through the inlet tube 19 and the adjusting tube 35 to the recess 23 of the armature 40. Through the openings 25 in the valve needle 22 the fluid may flow to the recess 24 of the valve body 20 and to the fluid outlet portion 28. If the valve needle 22 allows a fluid flow through the fluid outlet portion 28 in an opening position the fluid may flow through the injection nozzle 30.

The spring element 31 can force the valve needle 22 via the first spring rest 32 and the second spring rest 34 into its closing position. It is depending on the force balance between the force on the valve needle 22 caused by the actuator unit 16 and the force on the valve needle 22 caused by the spring element 31 whether the valve needle 22 is in its closing position or not.

What is claimed is:

1. An adjusting and filter arrangement for an injection valve, the injection valve comprising
a housing including a central longitudinal axis, the housing comprising a cavity with a fluid inlet portion and a fluid outlet portion,
a valve needle axially movable in the cavity, the valve needle preventing a fluid flow through the fluid outlet portion in a closing position and releasing the fluid flow through the fluid outlet portion in further positions, and
a spring element being mechanically coupled to the valve needle and being designed to exert an axial force on the valve needle,
the adjusting and filter arrangement being arrangeable in the cavity between the fluid inlet portion and the fluid outlet portion and comprising
a filter element being formed as a filtration body block and being designed to filter the fluid flowing from the fluid inlet portion to the fluid outlet portion,
an adjusting element being designed to be rigidly coupled to the housing and to preload the spring element and being formed as an outer casing for the filter element, and
a spring guiding element extending in axial direction and being designed to be in engagement with the spring element,
wherein the adjusting element and the spring guiding element are forming a one-piece element.

2. The adjusting and filter arrangement according to claim 1, wherein the adjusting and filter arrangement comprising an orifice being designed to allow a fluid flow from the fluid inlet portion to the fluid outlet portion and to dampen a pressure fluctuation at the fluid outlet portion.

3. The adjusting and filter arrangement according to claim 2, wherein the filter element being arranged at a first end of the adjusting and filter arrangement and the orifice being arranged at a second end of the adjusting and filter arrangement, the first end being opposite to the second end of the adjusting and filter arrangement.

4. The adjusting and filter arrangement according to claim 1, wherein the spring guiding element has the shape of a cylindrical piston.

5. The adjusting and filter arrangement according to claim 2, wherein the spring guiding element comprises the orifice.

6. An injection valve comprising the adjusting and filter arrangement according to claim 1.

7. The injection valve according to claim 6, wherein the adjusting element being arranged in the cavity in a manner that the adjusting element is force-fit coupled to the housing.

8. The injection valve according to claim 6, wherein the adjusting and filter arrangement comprising an orifice being designed to allow a fluid flow from the fluid inlet portion to the fluid outlet portion and to dampen a pressure fluctuation at the fluid outlet portion.

9. The injection valve according to claim 8, wherein the filter element being arranged at a first end of the adjusting and filter arrangement and the orifice being arranged at a second end of the adjusting and filter arrangement, the first end being opposite to the second end of the adjusting and filter arrangement.

10. The injection valve according to claim 6, wherein the spring guiding element has the shape of a cylindrical piston.

11. The injection valve according to claim 6, wherein the spring guiding element comprises the orifice.

12. An adjusting and filter arrangement for an injection valve with a housing, the housing comprising a cavity with a fluid inlet portion and a fluid outlet portion, a valve needle axially movable in the cavity, the valve needle preventing a fluid flow through the fluid outlet portion in a closing position and releasing the fluid flow through the fluid outlet portion in further positions, and a spring element being mechanically coupled to the valve needle and being designed to exert an axial force on the valve needle,
wherein the adjusting and filter arrangement is arranged in the cavity between the fluid inlet portion and the fluid outlet portion and comprises a filter element operable to filter the fluid flowing from the fluid inlet portion to the fluid outlet portion, an adjusting element operable to be rigidly coupled to the housing and to preload the spring element and being formed as an outer casing for the filter element, and
a spring guiding element extending in an axial direction and engaging with the spring element, wherein the adjusting element and the spring guiding element are forming a one-piece element.

13. The adjusting and filter arrangement according to claim 12, wherein the adjusting and filter arrangement comprising an orifice being designed to allow a fluid flow from the fluid inlet portion to the fluid outlet portion and to dampen a pressure fluctuation at the fluid outlet portion.

14. The adjusting and filter arrangement according to claim 13, wherein the filter element being arranged at a first end of the adjusting and filter arrangement and the orifice being arranged at a second end of the adjusting and filter arrangement, the first end being opposite to the second end of the adjusting and filter arrangement.

15. The adjusting and filter arrangement according to claim 12, wherein the spring guiding element has the shape of a cylindrical piston.

16. The adjusting and filter arrangement according to claim 13, wherein the spring guiding element comprises the orifice.
